(19) United States
(12) Patent Application Publication
(10) Pub. No.: US 2026/0187705 A1
(43) Pub. Date: Jul. 2, 2026

(54) ORDER PREDICTION AND AUTOMATED CART CREATION

(71) Applicant: Walmart Apollo, LLC, Bentonville, AR (US)

(72) Inventors: Yanan Cao, Mountain View, CA (US); Sonal Suresh Bathe, Sunnyvale, CA (US); Sinduja Subramaniam, Sunnyvale, CA (US); Evren Korpeoglu, San Jose, CA (US)

(73) Assignee: Walmart Apollo, LLC, Bentonville, AR (US)

(21) Appl. No.: 19/007,329

(22) Filed: Dec. 31, 2024

(51) Int. Cl. G06Q 30/0601; G06N 20/00

(52) U.S. Cl. CPC G06Q 30/0635; G06N 20/00

(57) ABSTRACT

Example implementations relate to order prediction and automated cart creation. In an example, basket features, item features, and order features associated with a profile are inputted into a predictive model and daily order predictions are outputted by the predictive model. The daily order predictions are inputted into a grouping algorithm to output an order predictability. Profiles are segmented into respective order predictability cohorts of a plurality of order predictability cohorts based on respective order predictabilities. A cart may be automatically created for at least one daily order prediction associated with at least one profile when a respective order predictability cohort belongs to a predetermined order predictability cohort.

### BACKGROUND

Platforms for e-commerce and retail operations may be implemented on servers and networks. Massive numbers of orders may be received on these platforms via such networks. Some of the orders may exhibit patterns of repeatability.

### BRIEF DESCRIPTION OF THE DRAWINGS

To facilitate further description of the embodiments, the following drawings are provided in which:

FIG. 1 illustrates a front elevational view of a computer system that is suitable for implementing aspects disclosed herein, according to an example embodiment.

FIG. 2 illustrates a representative block diagram of elements included in the circuit boards inside a chassis of the computer system of FIG. 1, according to an example embodiment.

FIG. 3A illustrates a schematic block diagram of a system that includes a replenishment system that can perform a computer-implemented method for order prediction and automated cart creation, according to an example embodiment.

FIG. 3B illustrates a schematic block diagram of an architecture of a replenishment system included in a system therewith, according to an example embodiment.

FIG. 4 illustrates a flowchart of a computer-implemented method for order prediction and automated cart creation, according to an example embodiment.

FIG. 5A illustrates a tree-based essentials prediction sub-process of a method for order prediction and automated cart creation, according to an example embodiment.

FIG. 5B illustrates a customer segmentation sub-process of a method for order prediction and automated cart creation, according to an example embodiment.

FIG. 5C illustrates a feedback loop for item reranking sub-process of a method for order prediction and automated cart creation, according to an example embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for various lengths of time, e.g., permanent, or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DETAILED DESCRIPTION

Users (also referred to herein as customers and/or profiles (e.g., of customers)) of e-commerce websites (e.g., e-commerce marketplaces, digital storefronts, online retail platforms, etc.) encounter overhead (e.g., significant tedium) in manually building/rebuilding their shopping carts (e.g., grocery baskets) of items (e.g., products) for purchase/repurchase, especially in the case of frequent purchases/repurchases of essential items (e.g., items actually or imminently needed by the user). In some embodiments, an essential item can include personal hygiene products (e.g., toothpaste, shampoo, deodorant, body wash, etc.), certain food products (e.g., milk, bread, pasta, rice, eggs, poultry, meat, poultry, seafood, cold cuts, produce, etc.), certain recreational and/or occupational supplies (e.g., pens, notebooks, staples, paints, brushes, pencils, sketchbooks, etc.), household essentials (e.g., trash bags, paper towels, toilet paper, cleaner sprays, batteries, etc.), baby products (e.g., baby wipes, diapers, baby formula, etc.), over-the-counter (OTC) medicines and/or supplements (e.g., antihistamines, decongestants, fish oil, melatonin, etc.), and/or pet products (dog food, dog treats, dog sprays, etc.).

Existing solutions like cart restoration, one-click reorders, and/or subscriptions have shortcomings, such as failing to account for item inventory changes and lacking flexibility, thus requiring proactive user input, circumstantial awareness, and/or additional network traffic and/or computational resources associated with users placing supplemental orders.

Addressing these issues posed by present e-commerce systems/websites and methodologies may be useful for improving e-commerce website bandwidth and/or resource availability, reducing e-commerce website network congestion due to user traffic, effectuating item/shopping cart conversion, and improving user satisfaction.

Some existing solutions may leverage general predictive models for suggesting items for purchase/repurchase to users-however, these general predictive models typically are not fully automated and require manual checkout and affirmative user feedback for subsequent improvements, thus causing further inconvenience and aggravation for users.

Some embodiments disclosed herein involve a replenishment system, a machine learning-powered system designed to automate order creation and checkout for eligible users (e.g., customers who are segmented into order predictability cohorts according to respective order predictabilities that are determined and meet predetermined thresholds), thus providing a complete no-touch grocery shopping solution for users (e.g., e-commerce users). The replenishment system can address the problems described above using essentials predictions for order predictability segmented users.

In some embodiments disclosed herein, the methodology can include automatic steps, such as:
a. Running a Customer Segmentation Pipeline on users at periodic intervals (e.g., weekly) to segment users with predetermined thresholds of order predictability (e.g., high-predictability and/or moderate-predictability) based on determined order predictabilities (e.g., using a grouping algorithm such as single order) for a predetermined historical time-period (e.g., past 4 weeks);
b. Running an Essentials Prediction Pipeline to rank predicted items (e.g., essential predicted items) for the segmented users with the predetermined thresholds of order predictability, along with predicted item quantities, basket sizes, and/or replenishment timing predictions, etc.;
c. Running a Feedback Loop Pipeline based on any user modifications to predicted items in the predicted order (e.g., amendments, substitutions, additions, etc.) and incorporating output thereof (e.g., automatically) to re-rank the ranked predicted items based on dynamic user interactions;
d. Removing any predicted items that are out-of-stock, already subscribed to, or that have an ineligible fulfillment type (e.g., online-only, pickup-only, membership exclusive offering, etc.);
e. Creating the predicted order (e.g., populating a digital shopping cart) and checking out with the remaining predicted items (e.g., essential predicted items) based on the recommended/predicted quantities for each predicted item, the actual or imminent needs thereof, etc. for the eligible segmented users determined to require replenishment of the predicted items, and booking fulfillment slots for home delivery, in-home delivery (e.g., customer can choose to deliver into their house and organize in their refrigerator for a further no-touch experience), and/or store pickup;
f. Sending users notifications (e.g., via calendar reminders, emails, texts, push-notifications, e-commerce website messages, etc.) with a reminder to review and/or modify their created predicted order (before and/or after checkout) and permitting modifications and/or cancellations (e.g., within a predetermined feedback time-period and/or prior to fulfillment commencement);
g. Fulfilling the created and checked out order (e.g., upon user acceptance and/or passage of the predetermined feedback time-period) by one or more of home delivery, in-home delivery, and/or store pickup, etc.

A system that includes the replenishment system can automate the creation and checkout of orders and obtainment of feedback, minimizing the need for manual actions by users. By integrating these sophisticated algorithms and machine learning techniques, the replenishment system enhances computer functionality, optimizing the efficiency and accuracy of automated grocery shopping, and representing a significant advancement in e-commerce technology.

In some embodiments, technical problems solved by the systems and methods described herein can include one or more of: (1) reducing manual intervention and overhead in building/rebuilding shopping carts for frequent purchases of essential items (e.g., building/rebuilding shopping carts may be associated with loss of conversion opportunities for e-commerce websites); (2) improving e-commerce website bandwidth availability and/or reducing network congestion by automating the order creation and checkout process; (3) enhancing computer functionality by integrating sophisticated algorithms and machine learning techniques to optimize the efficiency and/or accuracy of automated grocery shopping; (4) addressing limitations of existing solutions like cart restoration, one-click reorders, and subscriptions, which may fail to account for inventory changes and lack flexibility, etc.; (5) overcoming challenges with general predictive models that typically are not fully automated and require manual checkout and affirmative user feedback for subsequent improvement; (6) improving the accuracy of predicting customer needs and/or replenishment timing by utilizing machine learning algorithms to analyze historical purchase data (e.g., store and online transaction data) and customer behavior; (7) enhancing personalization of the shopping experience for users by segmenting customers based on their order predictability and tailoring recommendations accordingly; (8) implementing a dynamic feedback loop to rapidly adapt to changes in customer behavior and/or preferences, improving the accuracy of future predictions; (9) optimizing inventory management by predicting customer needs more accurately, potentially reducing overstocking and/or stockouts; and/or (10) streamlining the e-commerce process by automating order creation, review, and/or checkout, which may improve conversion rates and customer satisfaction.

Relatedly, in some embodiments, technical solutions to the technical problems identified herein can include one or more of: (1) a machine learning-powered system that automates order creation and checkout for users (e.g., eligible users) based on their order predictability; (2) implementation of a Customer Segmentation Pipeline that can run (e.g., periodically) to identify users with threshold order predictabilities (e.g., high and/or moderate order predictabilities) based on historical data (e.g., historical store and online transaction data); (3) an Essentials Prediction Pipeline that can: perform feature extraction and/or analysis, predict items (e.g., essential items), and/or rank the predicted items, along with predicted quantities of the predicted items, predicted basket sizes, and/or predicted replenishment timings; (4) utilization of a Feedback Loop Pipeline that can incorporate/analyze (e.g., automatically) user modifications to predicted orders and/or predicted items thereof, allowing for enhanced predicted item accuracy and/or dynamic re-ranking of predicted items based on ongoing customer interactions; (5) an Order Creation & Order Review Pipeline for removing out-of-stock, subscribed, and/or ineligible fulfillment type predicted items from predicted orders; (6) creation of predicted orders with recommended/predicted quantities for segmented users determined to require replenishment of predicted items (e.g., essential items) using the Order Creation & Order Review Pipeline; (7) an automated process for checkout and/or fulfillment commencement upon user acceptance or passage of the predetermined feedback time-period via the Order Creation & Order Review Pipeline; (8) implementation of a notification system that can send reminders to users to review their created predicted orders (before and/or after checkout), allowing for modifications and/or cancellations, such as within a predetermined feedback time-period; (9) integration of multiple data sources, including historical store and online transaction data, user and/or user-item data, customer feedback and/or customer behaviors, and/or dynamic store and online transaction data to inform/update/tune the prediction model; (10) application of advanced algorithms such as grouping algorithms (e.g., single order) for customer segmentation and supervised learning algorithms (e.g., XGBoost, logistic regression, and/or deep learning models, etc.) for prediction of the predicted items (e.g., essential items); (11) balancing performance and computational cost; (12) utilization of statistical estimators for quantity prediction and random forest model for predicting replenishment timing; (13) integration of user level behavioral data and/or item level behavioral data to generate classification rules for predicting future customer behavior; (14) application of association rule mining techniques to identify relationships between customer segments, profiles, and/or product items for improved predictions/recommendations; and/or (15) implementation of a system architecture that includes the Customer Segmentation Pipeline, the Essentials Prediction Pipeline, the Feedback Loop Pipeline, and/or the Order Creation & Order Review Pipeline to enable seamless automated replenishment.

According to an example embodiment, a system is provided. The system can include a processor and a non-transitory computer-readable medium storing computing instructions that, when executed on the processor, can cause the processor to perform various steps for each profile of a plurality of profiles. Basket features, item features, and order features can be input into a predictive model. Daily order predictions can be output by the predictive model. The daily order predictions can include predicted items for repurchase, a predicted basket size that includes an aggregate quantity of the predicted items for repurchase, and a predicted individual quantity of each of the predicted items for repurchase. The daily order predictions can be input into a grouping algorithm to output an order predictability. The profile can be segmented into an order predictability cohort of a plurality of order predictability cohorts based on the order predictability. Each order predictability cohort of the plurality of order predictability cohorts can correspond to a respective predetermined threshold of order predictability. A cart creation can be automated for at least one daily order prediction of the daily order predictions when the order predictability cohort belongs to at least one predetermined order predictability cohort of the plurality of order predictability cohorts. A checkout of the cart creation can be automated for the at least one daily order prediction of the daily order predictions when the profile does not provide feedback within a predetermined feedback time-period.

According to an example embodiment, a computer-implemented method is provided that can include various steps for each customer of a plurality of customers. Basket features, item features, and order features can be input into a predictive model. Daily order predictions can be output by the predictive model. The daily order predictions can include predicted items for repurchase, a predicted basket size that includes an aggregate quantity of the predicted items for repurchase, a predicted individual quantity of each of the predicted items for repurchase, and a ranking of the predicted items for repurchase based on essentiality. The predictive model can be a tree-based predictive model. The daily order predictions can be input into a grouping algorithm to output an order predictability. The grouping algorithm can be single order. The customer can be segmented into an order predictability cohort of a plurality of order predictability cohorts based on the order predictability. Each order predictability cohort of the plurality of order predictability cohorts can correspond to a predetermined threshold of order predictability. A cart creation can be automated for at least one daily order prediction of the daily order predictions when the order predictability cohort belongs to at least one predetermined order predictability cohort of the plurality of order predictability cohorts. A checkout of the cart creation can be automated for the at least one daily order prediction of the daily order predictions when the customer does not provide feedback within a predetermined feedback time-period. When the customer does provide the feedback within the predetermined feedback time-period, feedback features can be extracted from the feedback using a feedback-based prediction model. The predictive model can be updated to output reranked predicted items of the predicted items based on the feedback features.

According to an example embodiment, a non-transitory computer-readable medium storing instructions can be provided. The instructions, upon execution by a processor, can cause the processor to perform operations including a computer-implemented method. The computer-implemented method can include various steps for each customer of a plurality of customers. Basket features, item features, and order features can be input into a predictive model. Daily order predictions can be output by the predictive model. The daily order predictions can include predicted items for repurchase, a predicted basket size that includes an aggregate quantity of the predicted items for repurchase, a predicted individual quantity of each of the predicted items for repurchase, and a ranking of the predicted items for repurchase based on essentiality. The daily order predictions can be input into a grouping algorithm to output an order predictability. The customer can be segmented into an order predictability cohort of a plurality of order predictability cohorts based on the order predictability. Each order predictability cohort of the plurality of order predictability cohorts can correspond to a predetermined threshold of order predictability. A cart creation can be automated for at least one daily order prediction of the daily order predictions when the order predictability cohort belongs to at least one predetermined order predictability cohort of the plurality of order predictability cohorts. Certain predicted items of the predicted items can be removed that have subscriptions, are out-of-stock, or have an ineligible fulfillment type from the cart creation. A checkout of the cart creation can be automated for the at least one daily order prediction of the daily order predictions when the customer does not provide feedback within a predetermined feedback time-period.

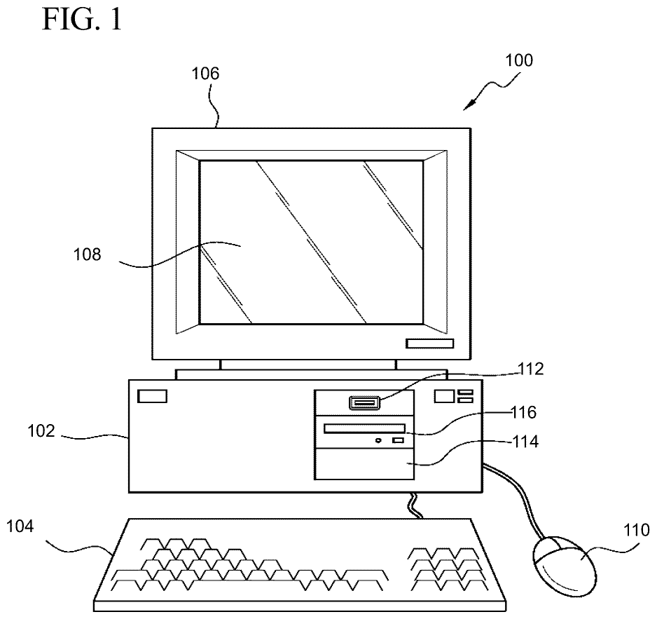

FIG. 1 illustrates a front elevational view of a computer system that is suitable for implementing aspects disclosed herein, according to an example embodiment.

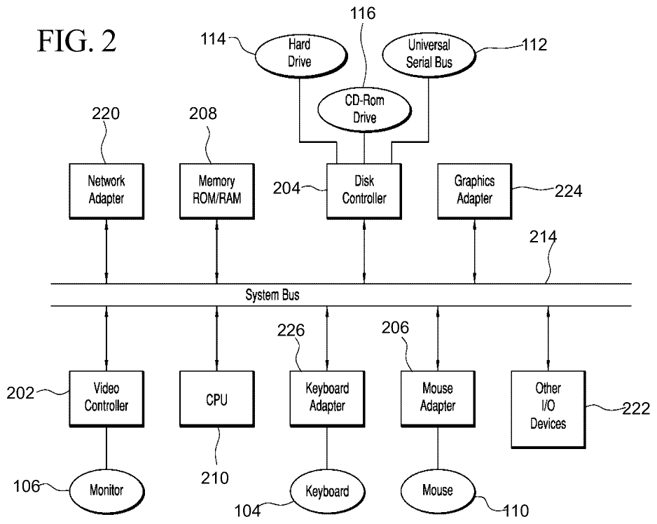

FIG. 2 illustrates a representative block diagram of elements included in the circuit boards inside a chassis of the computer system of FIG. 1, according to an example embodiment.

FIG. 1 illustrates an example embodiment of a computer system 100, all of which or a portion of which can be suitable for (i) implementing at least partial or all example embodiments of the techniques, methods, and systems and/or (ii) implementing and/or operating part or all example embodiments of the non-transitory computer readable media described herein. As an example, a different or separate one of the computer system 100 (and its internal components, or at least one element of the computer system 100) can be suitable for implementing partial or all the techniques described herein. The computer system 100 can comprise a chassis 102 which can contain at least one circuit boards (not shown), a Universal Serial Bus (USB) port 112, a Compact Disc Read-Only Memory (CD-ROM), a Digital Video Disc (DVD) drive 116, and/or a hard drive 114. A representative block diagram of the elements included on the circuit boards inside the chassis 102 is shown in FIG. 2, according to an example embodiment. A central processing unit (CPU) 210 illustrated in FIG. 2 can be coupled to a system bus 214 in FIG. 2. In various example embodiments, an architecture of the CPU 210 can be compliant with a variety of commercially distributed architecture families.

Continuing with FIG. 2, a system bus 214 can be coupled to at least one memory storage unit 208 that can include both read only memory (ROM) and random access memory (RAM). Non-volatile portions of the memory storage unit 208 and/or the ROM can be encoded with a boot code sequence suitable for restoring the computer system 100 (FIG. 1) to a functional state, such as after a system reset. In addition, the memory storage unit 208 can include microcode, such as a Basic Input-Output System (BIOS). In some example embodiments, the at least one memory storage units of the various embodiments disclosed herein can include the memory storage unit 208, a USB-equipped electronic device (e.g., an external memory storage unit (not shown) coupled to the USB port 112 (FIGS. 1-2), the hard drive 114 (FIGS. 1-2), the CD-ROM, the DVD, the Blu-Ray, and/or other suitable media, such as media configured to be used for the CD-ROM and/or the DVD drive 116 (FIGS. 1-2). Non-volatile and/or non-transitory memory storage unit(s) can refer to the portions of the memory storage units(s) that are non-volatile memory and are not transitory signals. In the same or different example embodiments, the at least one memory storage units of the various embodiments disclosed herein can include an operating system, which can be a software program that manages the hardware and software resources of a computer and/or a computer network. The operating system can perform tasks such as, for example, at least one of controlling and/or allocating memory, prioritizing the processing of instructions, controlling input and/or output devices, facilitating networking, and/or managing files. Example operating systems can include at least one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further example operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” can mean various types of computational circuits, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, and/or various other types of processors and/or processing circuits capable of performing the desired functions. In some example embodiments, the at least one processors of the various embodiments disclosed herein can comprise the CPU 210.

In the example embodiment illustrated in FIG. 2, various I/O devices such as a disk controller 204, a graphics adapter 224, a video controller 202, a keyboard adapter 226, a mouse adapter 206, a network adapter 220, and/or other I/O devices 222 can be coupled to the system bus 214. The keyboard adapter 226 and/or the mouse adapter 206 can be coupled to a keyboard 104 (FIGS. 1-2) and/or a mouse 110 (FIGS. 1-2), respectively, of the computer system 100 (FIG. 1). The graphics adapter 224 and/or the video controller 202 can be indicated as distinct units in FIG. 2, the video controller 202 can be integrated into the graphics adapter 224, or vice versa in other example embodiments. The video controller 202 can be suitable for refreshing a monitor 106 (FIGS. 1-2) to display images on the screen 108 (FIG. 1) of the computer system 100 (FIG. 1). The disk controller 204 can control the hard drive 114 (FIGS. 1-2), the USB port 112 (FIGS. 1-2), the CD-ROM, and/or the DVD drive 116 (FIGS. 1-2). In other example embodiments, distinct units can be used to control each of these devices separately.

In some example embodiments, the network adapter 220 can comprise and/or be implemented as a WNIC (wireless network interface controller) card (not shown) plugged and/or coupled to an expansion port (not shown) in the computer system 100 (FIG. 1). In other example embodiments, the WNIC card can be a wireless network card built into computer system 100 (FIG. 1). A wireless network adapter can be built into the computer system 100 (FIG. 1), such as by having wireless communication capabilities integrated into the motherboard chipset (not shown) or implemented via at least one dedicated wireless communication chips (not shown), connected through a PCI (peripheral component interconnector), a PCI express bus of the computer system 100 (FIG. 1), and/or the USB port 112 (FIG. 1). In other example embodiments, the network adapter 220 can comprise and/or be implemented as a wired network interface controller card (not shown).

Although some components of the computer system 100 (FIG. 1) might not be shown in the figures, such components and their interconnection may be appreciated by those of ordinary skill in the art. Accordingly, further details concerning the construction and/or composition of the computer system 100 (FIG. 1) and/or the circuit boards inside the chassis 102 (FIG. 1) might be omitted herein.

When the computer system 100 in FIG. 1 is running, program instructions stored on a USB drive in the USB port 112, on the CD-ROM, the DVD in the CD-ROM, and/or the DVD drive 116, on the hard drive 114, and/or in the memory storage unit 208 (FIG. 2) can be executed by the CPU 210 (FIG. 2). At least a portion of the program instructions, such as stored on at least one of these devices, can be suitable for carrying out all or at least a part of the techniques described herein. In various example embodiments, the computer system 100 can be reprogrammed with at least one of at least one module, system, application, and/or database, such as those described herein, to convert a general purpose computer to a special purpose computer. For purposes of illustration, programs and other executable program components are shown herein as discrete systems, although it is understood that such programs and components may reside, at various times, in different storage components of computer system 100, and can be executed by the CPU 210. Additionally, or alternatively, the systems and/or procedures described herein can be implemented in hardware, and/or a combination of hardware, software, and/or firmware. For example, at least one application specific integrated circuit (ASIC) can be programmed to carry out at least one of the systems and procedures described herein. For example, at least one of the programs and/or executable program components described herein can be implemented in at least one ASIC.

Although the computer system 100 is illustrated as a desktop computer with reference to FIG. 1, it is not limited thereto. The computer system 100 can take a different form factor and can still having functional elements like those described with respect to the computer system 100. In some example embodiments, the computer system 100 can comprise at least one of at least one single computer, a single server, a cluster/collection of computers/servers, and/or a cloud of computers/servers. Typically, a cluster or collection of servers can be used when the demand on computer system 100 exceeds the reasonable capability of a single server and/or computer. In some example embodiments, the computer system 100 can comprise a portable computer, such as a laptop computer. In some example embodiments, the computer system 100 can comprise a mobile device, such as a smartphone. In some example embodiments, the computer system 100 can comprise an embedded system.

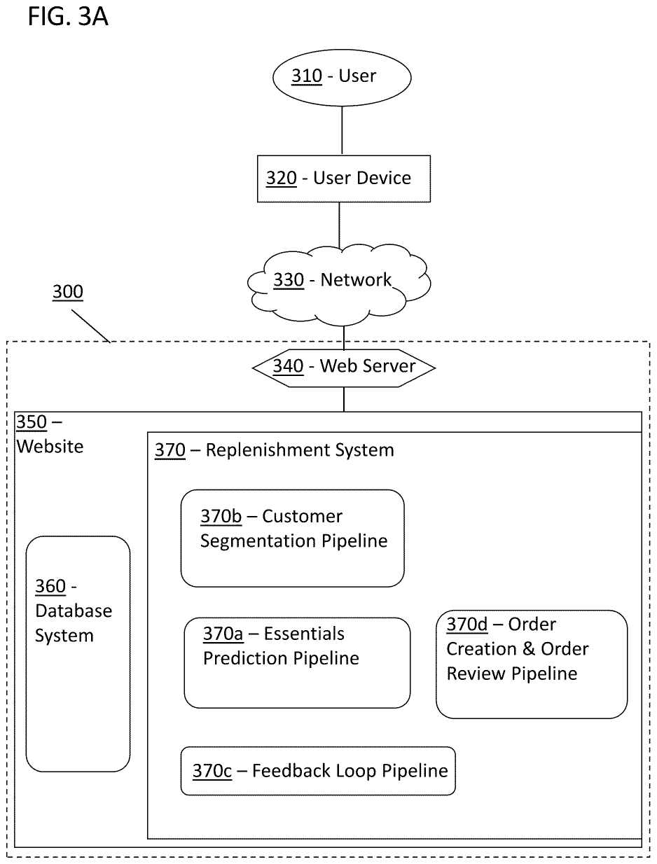

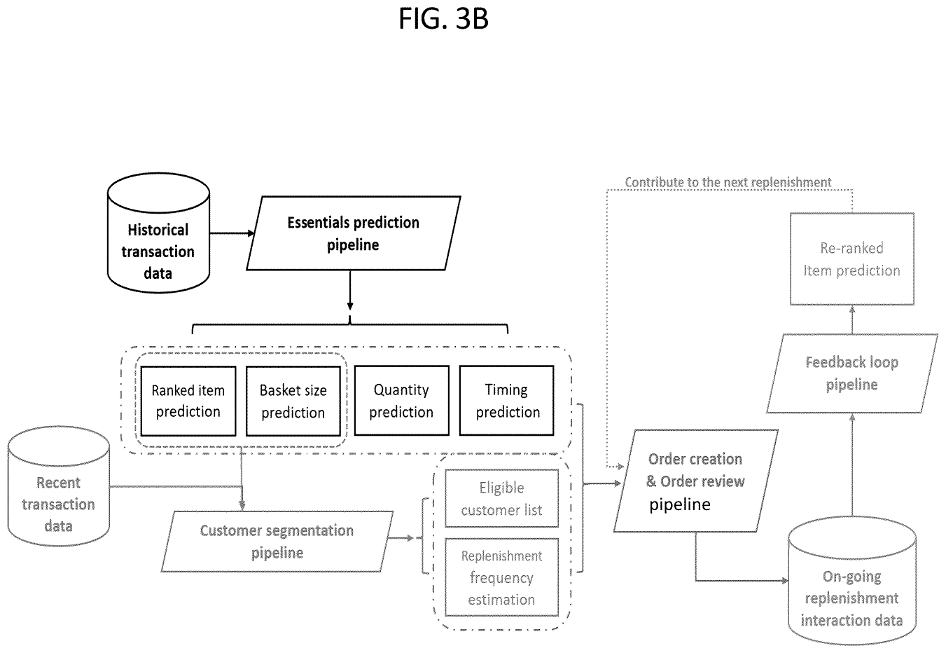

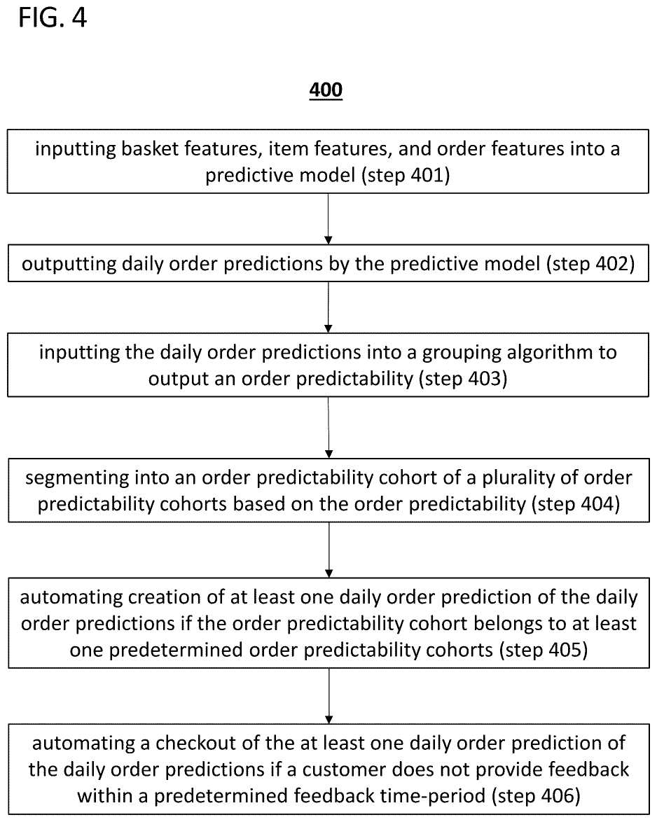

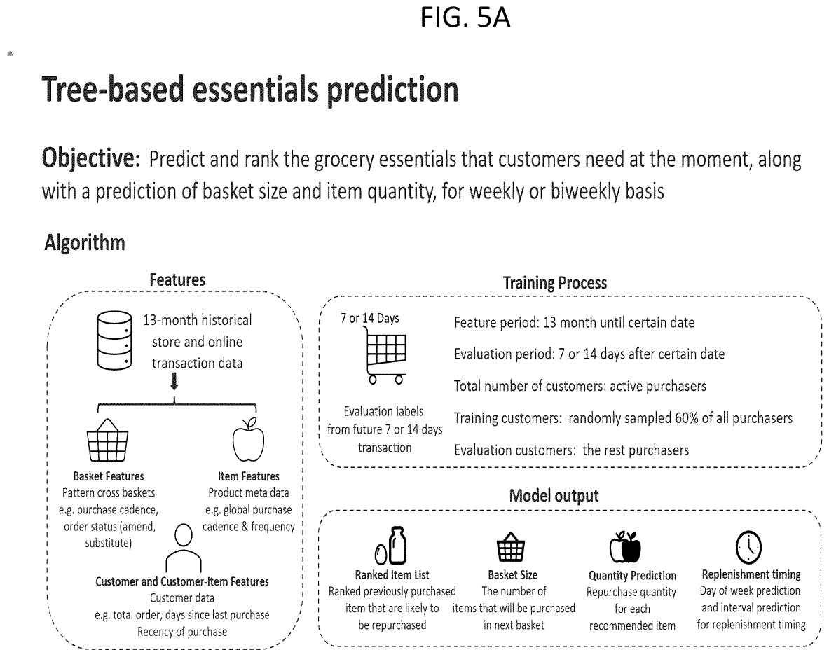

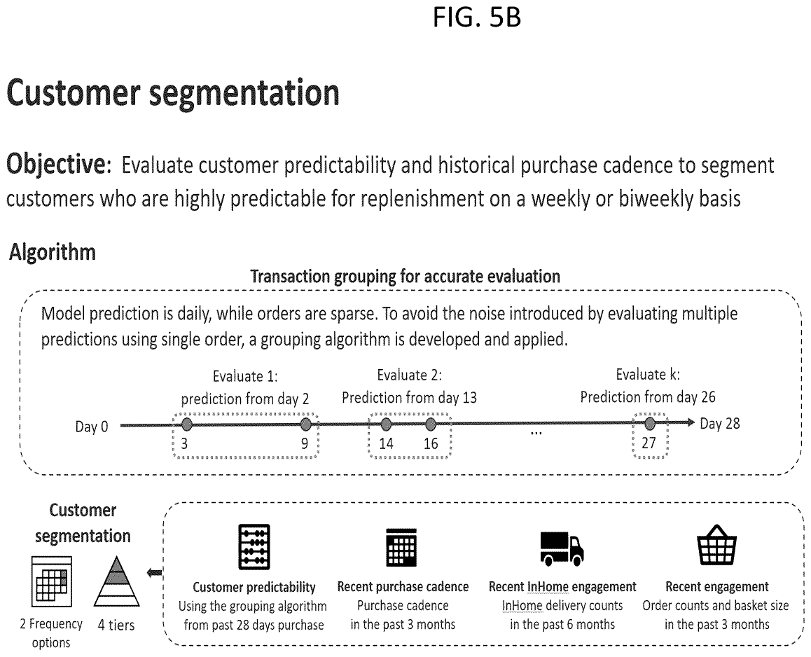

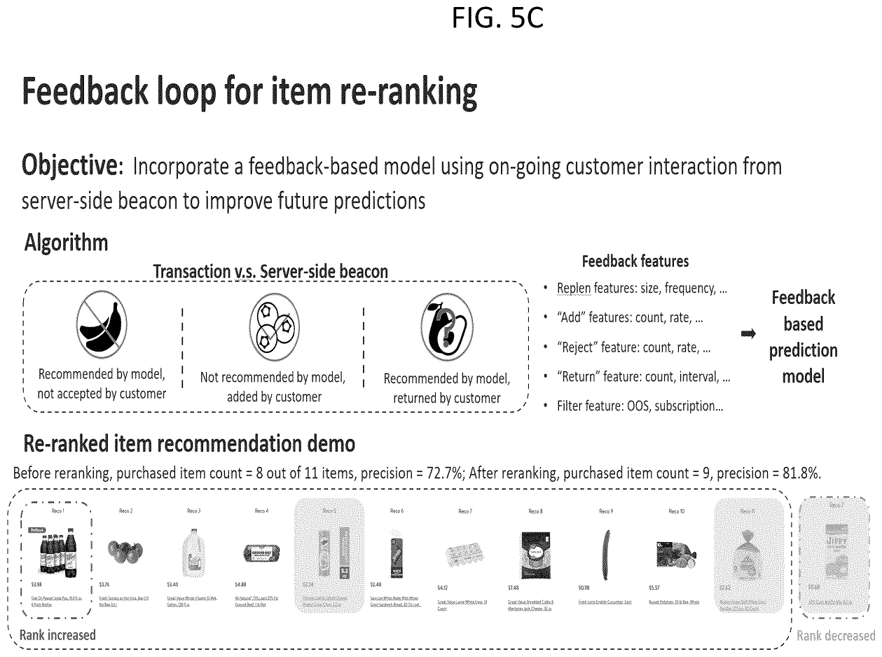

FIG. 3A illustrates a schematic block diagram of a system that includes a replenishment system that can perform a computer-implemented method for order prediction and automated cart creation (e.g., the computer-implemented method shown and described with reference to FIG. 4 and/or the sub-processes shown and described with reference to FIGS. 5A, 5B, and/or 5C), according to an example embodiment.

FIG. 3B illustrates a schematic block diagram of an architecture of a replenishment system included in a system therewith (e.g., the replenishment system illustrated and described with reference to FIG. 3A), according to an example embodiment. In some example embodiments, a system 300 can include system components, such as a web server 340, at least one website 350 (e.g., an e-commerce website/marketplace, a digital storefront, an online retail platform, etc.) that can host and/or otherwise be connected to at least one database system 360 (e.g., a store and online transaction data repository (e.g., historical transaction data, dynamic/recent transaction data, etc.), at least one collective store and online transaction data repository, such as shared between multiple e-commerce vendors, websites, and/or brands, a user and/or user-item data repository, eligible customer lists, an essentials prediction pipeline data repository, a customer segmentation pipeline data repository, a feedback loop pipeline data repository, an order creation & order review pipeline data repository, etc.) and/or a Replenishment System 370. The web server 340 can be connected to a network 330.

A user 310 of the user device 320 can interact with a user experience (UX) interface of the website 350 and/or the Replenishment System 370 via the network 330.

The system 300 can comprise a processor and a non-transitory computer-readable medium storing computing instructions that, when executed, cause the processor to perform various operations, including order prediction and automated cart creation via the Replenishment System 370 using essentials predictions for order predictability segmented users.

The Replenishment System 370 can, for example, implement the computer-implemented method 400 illustrated and described with reference to FIG. 4. The Replenishment System 370 can include a Customer Segmentation Pipeline 370b, an Essentials Prediction Pipeline 370a, a Feedback Loop Pipeline 370c, and/or an Order Creation & Order Review Pipeline 370d. The Customer Segmentation Pipeline 370b can perform user predictability segmentation and/or eligibility determination, such as illustrated and described with reference to the example embodiment of FIG. 5B. The Essentials Prediction Pipeline 370a can predict baskets and sizes thereof, predict items (e.g., essential items) included in the predicted baskets, predict quantities of the predicted items, rank the predicted items, predict fulfillment methods, and/or predict replenishment timings of the predicted items and/or the predicted baskets, etc., using a predictive model (e.g., a tree-based essentials prediction model), such as illustrated and described with reference to the example embodiment of FIG. 5A. The Feedback Loop Pipeline 370c can initialize a feedback loop that receives/analyzes customer feedback and/or behavior changes based on, for example, on-going replenishment interaction data of the user, users belonging to a same segmented cohort, and/or similar users (e.g., modifications to predicted orders, purchases of new items and/or new frequencies of predicted items, new shopping trends/patterns, etc.), update/tune the predictive model, generate computer-readable instructions to modify the UX contents displayed to the user, and/or can perform predicted item reranking, such as illustrated and described with reference to the example embodiment of FIG. 5C. The Order Creation & Order Review Pipeline 370d can perform auto-checkout (including order evaluation & management), manage/amend the UX display on a graphical user interface (GUI) of the user device 320 (e.g., based on the generated computer-readable instructions to modify the UX), and/or manage user inputs thereto (e.g., transmit modifications made by the user to the Feedback Loop Pipeline 370c).

The system 300 and/or the system components thereof can each include a computer system, such as the computer system 100 (illustrated and described with respect to FIG. 1), and one or more can be a single computer; a single server; a cluster or collection of computers or servers; a cloud of computers or servers; and/or a combination thereof. In some example embodiments, a single computer system can host the system 300 and/or the system components thereof.

The network 330 can be the Internet or another suitable network for inter-device connectivity. In some example embodiments, the web server 340 can host the system 300, websites connected thereto (e.g., the at least one website 350), and/or mobile application servers, etc. For example, the web server 340 can host the system 300, a website connected thereto, and/or the system components of the system 300, and/or can provide a server that interfaces with an application (e.g., a mobile application) on the user device 320. This can allow for the user 310 to passively and/or actively engage with the system 300 and/or the system components thereof.

In some example embodiments, an internal network that is not open to the public can be used for communications between the system 300 and the system components thereof. Accordingly, in some example embodiments, the system 300, the system components thereof, and/or associated software can refer to a back end of a system operated by a network administrator of the system 300. The web server 340 and/or the system 300 (and/or software used by such systems) can refer to a front end of system, which can be accessed and/or otherwise used by the user 310 via the user device 320. In these or other example embodiments, the network administrator of the system 300 can manage the system 300 and/or the system components thereof, the processor(s) of the system 300, and/or the memory storage unit(s) of the system 300 using the input device(s) and/or display device(s) of the system 300.

In some example embodiments, the user device 320 can include a desktop computer, a laptop computer, a mobile device, and/or another endpoint device used by the user 310. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.).

In some example embodiments, the system 300 and/or the system components thereof can each include at least one input device (e.g., at least one keyboards, at least one keypads, at least one pointing devices such as a computer mouse or computer mice, at least one touchscreen displays, a microphone, etc.), and/or can include at least one display device (e.g., at least one monitor, at least one touch screen display, projector, etc.). In these example embodiments or other example embodiments, at least one of the input device(s) can be similar or identical to the keyboard 104 (FIG. 1) and/or the mouse 110 (FIG. 1). Further, at least one of the display device(s) can be similar or identical to the monitor 106 (FIG. 1) and/or the screen 108 (FIG. 1). The input device(s) and the display device(s) can be coupled to the system 300 and/or the system components thereof in a wired manner and/or a wireless manner, and the coupling can be direct and/or indirect, as well as local and/or remote. As an example of an indirect manner (which may or may not also be a remote manner), a keyboard-video-mouse (KVM) switch can be used to couple the input device(s) and the display device(s) to the processor(s) and/or the memory storage unit(s). In some example embodiments, the KVM switch also can be part of the system 300 and/or the system components thereof. In a similar manner, the processors and/or the non-transitory computer-readable media can be local and/or remote to each other.

The system 300 and/or the system components thereof can be stored in at least one memory storage units (e.g., non-transitory computer readable media), which can be similar or identical to the at least one memory storage units (e.g., non-transitory computer readable media) described above with respect to computer system 100 (FIG. 1). Also, in some embodiments, at least one database (e.g., the at least one database 360)/repositories included and/or connected to the system 300, and/or the system components thereof can be stored on a single memory storage unit, or the contents of that database can be spread across multiple ones of the memory storage units storing the at least one databases, depending on the size of the database and/or the storage capacity of the memory storage units.

The at least one database can include a structured (e.g., indexed) collection of data and can be managed by a suitable database management systems configured to define, create, query, organize, update, and manage database(s). Example database management systems can include MySQL (Structured Query Language) Database, PostgreSQL Database, Microsoft SQL Server Database, Oracle Database, SAP (Systems, Applications, & Products) Database, and IBM DB2 Database.

The system 300 and/or the system components thereof can be implemented using a suitable manner of wired and/or wireless communication. Accordingly, the system 300 can include software and/or hardware components configured to implement the wired and/or wireless communication. Further, the wired and/or wireless communication can be implemented using a singular or plural combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Example PAN protocol(s) can include Bluetooth, Zigbee, Wireless Universal Serial Bus (USB), Z-Wave, etc.; example LAN and/or WAN protocol(s) can include Institute of Electrical and Electronic Engineers (IEEE) 802.3 (also known as Ethernet), IEEE 802.11 (also known as WiFi), etc.; and example wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, example communication hardware can include wired communication hardware including, for example, at least one data buses, such as, for example, universal serial bus(es), at least one networking cables, such as, for example, coaxial cable(s), optical fiber cable(s), and/or twisted pair cable(s), any other suitable data cable, etc. Further example communication hardware can include wireless communication hardware including, for example, at least one radio transceivers, at least one infrared transceivers, etc. Additional example communication hardware can include at least one networking components (e.g., modulator-demodulator components, gateway components, etc.).

In many embodiments, the system 300 can be suitable to perform the computer-implemented method for order prediction and automated cart creation via the Replenishment System 370 using essentials predictions for order predictability segmented users, such as the example embodiment illustrated and described with reference to FIG. 4. In these or other example embodiments, one or more of the activities/steps of the example embodiment of the computer-implemented method 400 can be implemented as one or more computing instructions configured to run at one or more processors and configured to be stored at one or more non-transitory computer readable media. Such non-transitory computer readable media can be part of system 300, the system components, and/or the other system components thereof. The processor(s) can be similar or identical to the processor(s) described above with respect to the computer system 100 (FIG. 1). In some embodiments, the example embodiment of the computer-implemented method 400 of FIG. 4 and other steps/activities that can be included therein can include using a distributed network including distributed memory architecture to perform the associated steps/activities. This distributed architecture can reduce the impact on the network 330 and the system 300 resources to reduce congestion in bottlenecks while still allowing data to be accessible from a central location.

FIG. 4 illustrates a flowchart of a computer-implemented method for order prediction and automated cart creation, according to an example embodiment.

An example embodiment can include a computer-implemented method 400 for order prediction and automated cart creation. The computer-implemented method 400 can be implemented via a system that includes a replenishment system. For example, one or more steps of the computer-implemented method 400 can be implemented by the system 300 that includes the Replenishment System 370 as illustrated and described with reference to the example embodiment of FIG. 3A and/or in accordance with the architecture thereof as illustrated and described with reference to the example embodiment of FIG. 3B.

In some embodiments, the computer-implemented method 400 can include one or more of the following steps for at least one user (e.g., each user) of a plurality of users:

Inputting various features into a predictive model, including basket features, item (e.g., product) features, and/or order features (e.g., user and/or user-item features), etc. (step 401).

The predictive model can be included in the Essentials Prediction Pipeline 370a. The features that are input can be pre-extracted by a trained model (e.g., the predictive model itself and/or a discrete classification model which can also be included in the Essentials Prediction Pipeline 370a). These features can be extracted from a historical store and online transaction dataset associated with a predetermined historical time-period (e.g., 13-months). Additionally, or alternatively, the features can be received pre-extracted from the at least one database system 360 (e.g., the essentials prediction pipeline data repository) and/or a relevant training dataset (e.g., labelled historical store and online transaction data). The features input into the predictive model can further include order fulfillment types, special fulfillment type instructions input by the user, and/or relevant fulfillment type locations.

For example, the basket features can include, for one or more baskets associated with one or more users (e.g., global users, the user, region-specific users within a predetermined geographic distance of the user, other users with a predetermined threshold of similarity to the user, and/or other users that are segmented into a same order predictability cohort as the user, etc.): 1) purchase/order cadence and/or frequency, 2) total cost and/or predetermined budget indicia/patterns, 3) themes/trends/patterns (e.g., includes seasonal items, diet-specific items, organic items, on-sale items, cross-basket items, etc.), and/or 4) modification status (e.g., includes items modified by the user (e.g., amendments, substitutions, postponements, cancellations, removals, additions, updated quantities, etc.)). For example, the item features can include, for one or more items associated with one or more users: 1) product/item metadata (e.g., item attributes (e.g., SKU, brand, popularity, price, dimensions, sale status, promotion status and/or eligibility criteria, brand, etc.)), 2) purchase/order cadence and/or purchase/order frequency, 3) frequency and/or magnitudes of oversupply and/or undersupply, 4) irregular/aperiodic purchases/orders, 5) frequency of modifications and/or patterns thereof (e.g., affinity of the one or more users to readily substitute for lower priced items on sale and/or comparably priced premium items, etc.), and/or 6) categories/sub-categories (e.g., produce, meat, poultry, office supplies, etc.).

For example, the customer and customer-item features can include total purchases/orders, days since last purchase/order, recency of last purchase/order, and predetermined user preferences (e.g., maximum/minimum bags/boxes/installments, separation of fragile items, separation of meat items from produce items, order fulfillment types, etc.). Customer-item features can be generated by the system and can represent a synthesized combination of customer features and features of corresponding items. The order fulfillment types can include in-store pickup, home delivery, in-home delivery, locker delivery, third-party fulfillment, drop-shipping, hybrid fulfillment, etc. The relevant locations can include addresses associated with the order fulfillment types.

Order predictions can be output by the predictive model on a periodic basis (e.g., daily) (step 402). The order predictions can be output by the predictive model as included in the Essentials Prediction Pipeline 370a. The order predictions can include predicted items for repurchase (e.g., essential predicted items in actual or need of repurchase), predicted costs/budgets, essentiality imminent determinations/scores based on predetermined essentiality thresholds and/or windows/grace periods therefor, a predicted basket size that can include an aggregate quantity of the predicted items for repurchase, a predicted individual quantity of each of the predicted items for repurchase, a ranking of the predicted items for repurchase (e.g., based on essentiality determinations/scores), and/or item replenishment timings (e.g., intervals, dates, times, etc.).

In an embodiment, the daily order predictions, for the present day and/or one or more future days, can be dynamically modified by the predictive model based on real-time receipt/analysis of dynamic/recent store and online transaction data (e.g., received from the at least one database system 360). This data can include in-store purchases/orders, e-commerce website purchases/orders, item subscriptions, and items scanned during self-checkout and/or employee-assisted checkout. The dynamic/recent transaction data, such as received in real-time, can come from various vendors or brands, including e-commerce websites, subsidiaries, sister brands, and third-party vendors that share data (e.g., through the at least one database system 360), etc.

The Replenishment System 370 can determine actual item quantities versus predicted item quantities (e.g., via the Feedback Loop Pipeline 370c). In some embodiments, items (e.g., predicted items) can be identified when scanned and/or otherwise detected via a smart pantry of a user, a smart refrigerator of a user, a user engaged in self-checkout, a user engaged in employee-assisted check-out, and/or a user engaged in online manual cart creation and/or modification before/after checkout. When a potential oversupply and/or undersupply of one or more items is predicted, the Feedback Loop Pipeline 370 can update predicted item quantities (e.g., essential item quantities), predicted item replenishment timings, and/or generate notifications to a user regarding the same. These notifications can also be provided via a cashier and/or self-checkout interface/computing device therefor, or via an e-commerce website or application.

Additionally, when a user is scheduled to pick up an order containing predicted items purchased online, in-store, or from a cooperating third-party vendor that might result in oversupply and/or undersupply, a notification can be generated and sent to the user's device, e-commerce website, or the computing system used by the customer care employee preparing the order.

In an embodiment, users can scan/photograph barcodes/items in their pantry and input a corresponding essentiality or non-essentiality thereof, such as via an application used in conjunction with the Replenishment System 370 (e.g., the Essentials Prediction Pipeline 370a). The Replenishment System 370 can thus assess actual item quantities versus predicted item quantities for one or more of the predicted items.

### Essentials Prediction-Item Ranking Prediction

The predictive model can include a tree-based essentials prediction model, which may be implemented via a supervised machine learning algorithm (e.g., a gradient boosted machine learning model such as XGBoost), and the daily order predictions can include essential predicted items from among the predicted items. These essential predicted items can be needed for repurchase on at least a periodic basis (e.g., weekly and/or biweekly).

XGBoost can refer to a decision tree ensemble which can demonstrate strong performance. It can minimize the following objective function:

$$Objective = {\sum }_{i = 1}^{n} Loss ( {y}_{i} - {\hat{y}}_{i} ) + {\sum }_{k = 1}^{K} complexity ( {f}_{k} )$$

yᵢ can denote the actual label (an item is purchased or not), while ŷᵢ can denote the prediction. The second term in the objective function above can be a regularization based on the complexity of each tree.

$${\hat{y}}_{i} = {\sum }_{k = 1}^{K} {f}_{k} ( {x}_{i} )$$

k can denote the number of trees, fₖ can be a function indicating a decision tree.

In an example embodiment, the Replenishment System 370 (e.g., the predictive model) can be trained on features x₁ to x₉₂, such as generated from a 13-month purchase/order history and evaluated on the purchases/orders of the same customers in the following one-week and two-week period for different replenishment frequency options.

### Essentials Prediction-Basket Size Prediction

Basket size prediction can be performed at the customer level, which can require less computational power compared to essentials recommendation that can operate at the customer-item interaction level. At the customer level, the analysis can focus on overall patterns and trends in a customer's purchasing history, such as the total number of items and/or the total value of items a customer typically buys in a single transaction. This approach can aggregate data at a higher level, making it computationally efficient.

An artificial neural network, such as a multi-layer perceptron (MLP), can be utilized for this task. The MLP can provide an effective balance between prediction accuracy and computational efficiency.

The MLP can minimize the objective function:

$$Objective = {\sum }_{i = 1}^{n} Loss ( {y}_{i} - {\hat{y}}_{i} )$$

In this context, y_i can refer to the actual basket size in the customers' purchase/order in the following replenishment window, while y\hat{ }_i can denote the prediction of the next basket size.

$${\hat{y}}_{ι} = MLP ( {x}_{i} )$$

The features for training data can be derived from user historical purchase basket patterns, such as the recent purchase dates, recent purchase size and order value, historical purchase size and order value, and/or recent purchase cadence.

### Essentials Prediction-Quantity Prediction

The quantity of an item can be estimated based on the historically purchased/ordered quantity on each item and can show reliable performance.

The lower confidence interval of the average quantity estimation for each item can be expressed as:

$$\hat{y} = \overline{x} - z \frac{s}{\sqrt{n}}$$

Here, x̅ can refer to the sample mean of the quantity for an item, z can denote the confidence level value, s can denote the sample standard deviation, and n can denote the sample size.

This estimation can be evaluated using the objective function:

$$Objective = {\sum }_{i = 1}^{n} Loss ( {y}_{i} - {\hat{y}}_{i} )$$

In this case, yᵢ can represent the average purchase quantity in the following five orders, and the Loss function used can be the mean squared error (MSE loss).

### Essentials Prediction-Timing Prediction

A Random Forest, an ensemble tree model that applies bagging on weak decision tree learners, can be employed for item replenishment timing prediction. This model can minimize the objective function:

$$Objective = {\sum }_{i = 1}^{n} Loss ( {y}_{i} - {\hat{y}}_{i} )$$

In this scenario, yᵢ can denote the actual label (indicates whether the user placed an order within the following 2 days or not), ŷᵢ can denote the prediction, which can be derived from a majority vote from among multiple (e.g., several) weak learners.

During training, the model can select a random sample of the training data set with replacement. The features for training data can be derived from historical user purchase/order patterns, such as the recent purchase dates, recent purchase cadence, and statistical estimation of a predetermined time-period (e.g., a 13-month inter-purchase interval).

### Training the Predictive Model

Training the predictive model can include inputting historical store and online transaction data and/or customer data associated with a predetermined historical period for a group of users. This group of users can include active purchasers, training customers, segmented customers, and/or evaluation customers, etc. The basket features (e.g., order cadence, order status, amendments, substitutions, additions, cancellations, subtractions, etc.), the item features (e.g., item metadata, price, category, global order cadence and frequency), and customer and customer-item features (e.g., total order counts, days since last order, recency of order) can be extracted. Evaluation labels from a predetermined future time-period relative to the predetermined historical time-period can be input to assess the predictive model's performance on unseen data. The predictive model can be a tree-based essentials prediction model, and the daily order predictions can include essential predicted items needed for repurchase on a weekly and/or biweekly basis.

The daily order predictions can be input into a grouping algorithm (e.g., “single order”) to output an order predictability (step 403). The grouping algorithm can be included in the Customer Segmentation Pipeline 370b. This grouping algorithm can evaluate store and online transaction data (e.g., real-time/dynamic and/or historical) associated with a user to accurately assess the predictability of each customer's orders, avoiding noise from sparse orders by grouping daily predictions. The inputting of the daily order predictions into the grouping algorithm to output the order predictability can further include identifying actual orders associated with a predetermined historical time-period, wherein the actual orders can include pairs of consecutive-actual orders and/or a non-paired consecutive actual order. The grouping algorithm can also involve grouping the consecutive-actual orders and evaluating multiple daily order predictions that precede each of the consecutive-actual orders (e.g., from the day preceding an earlier constituent actual-order of a pair through the day preceding the day preceding the later constituent actual-order in the pair) to reduce data analysis noise and improve the accuracy of the order predictability output.

At least one of the users can be segmented into a corresponding order predictability cohort of a plurality of order predictability cohorts based on their order predictability (step 404). The segmentation of the at least one user of the user can be performed by the Customer Segmentation Pipeline 370b. The segmentation can be based on factors such as recent purchase cadence over a first predetermined time-period (e.g., over the past three months), recent in-home engagement over a second predetermined time-period (e.g., the past six months), and/or recent engagement metrics like order counts and basket size over a third predetermined time-period (e.g., the past 3 months). Each order predictability cohort of the order predictability cohorts can correspond to a respective predetermined threshold of order predictability and/or replenishment timing thereof. This segmentation may be performed, for example, on a weekly basis, using data from the prior month. Each of the plurality of order predictability cohorts can correspond to a tier from among a plurality of tiers for order predictability. These tiers can include, for example, a high-predictability tier, a moderate-predictability tier, a low-predictability tier, and a non-predictability tier. The predetermined order predictability cohorts can include the high-predictable tier and/or the moderate-predictability tier. Segmenting into the order predictability cohort of the plurality of order predictability cohorts based on the order predictability can be associated with a predetermined historical time-period and can be performed on a periodic basis (e.g., weekly). The predetermined historical time-period can be, for example, a prior month. Segmenting into the order predictability cohort of the plurality of order predictability cohorts based on the order predictability and/or determining the order predictability can also be based on purchase cadence associated with a first predetermined historical time-period, in-home engagement (including delivery counts over a second predetermined historical time-period), and customer engagement (including order counts and basket sizes over the first predetermined historical time-period). In an embodiment, segmentation can be further based on user preferences (e.g., consolidated orders, in-store pickup, delivery, immediacy, mutually dependent item necessities, etc.), geographic region, delivery routes, delivery methods, tolerated order windows, habitual oversupply/returns/cancellations, etc.

At least one daily order prediction of the daily order predictions can be created, such as by automatically generating/populating a cart (e.g., a digital shopping cart) which can be accessible by UX and/or an associated application/e-commerce website and/or scheduled for creation, when the order predictability cohort belongs to at least one predetermined order predictability cohorts and when one or more predicted items (e.g., essential predicted items) are due for replenishment (step 405). The at least one daily order prediction of the daily order predictions can be created by the Order Creation & Order Review Pipeline 370d. This step can include generating/sending notifications to the user regarding the created and/or scheduled daily order prediction (e.g., emails, texts, push-notifications, automated calls, calendar reminders, etc.) to give users an opportunity for order review, allowing for modifications and/or cancellations. In some embodiments, the system can automate the checkout of the daily order prediction when the user does not provide feedback within a predetermined feedback time-period.

In some embodiments, checkout of the at least one daily order prediction of the daily order predictions can be automated (e.g., for essential items that are actually or imminently needed), for example, when a customer does not provide feedback (e.g., modify, cancel, add, remove, amend, etc.) within a predetermined feedback time-period (step 406). However, the computer-implemented method 400 is not limited thereto; for example, automated checkout can occur (e.g., within a predetermined time-period preceding fulfillment) before the predetermined feedback time-period. The Order Creation & Order Review Pipeline 370d can checkout the at least one daily order prediction. The automated checkout can include the predetermined order fulfillment type (e.g., input by the user and/or pre-extracted from store and online transaction data). Additionally, or alternatively, the Replenishment System 370 (e.g., via the Order Creation & Order Review Pipeline 370d) can suggest/determine an order/locker pickup address/location within a predetermined distance, route, and/or time window of an actual or predicted user location, such as based on an essential item with a predetermined threshold of essentiality. When multiple predicted items are not yet actually essential (or below a predetermined threshold therefor) and are within a predetermined number of days for replenishment of one another or a future essential item, the Replenishment System 370 (e.g., via the Order Creation & Order Review Pipeline 370d) can consolidate the predicted items and adjust specific order fulfillment dates to avoid multiple deliveries/pickups and/or incurred checkout/delivery fees.

The foregoing may provide a seamless and efficient shopping experience. Any predicted items that are out-of-stock, already subscribed to, or that have an ineligible fulfillment type (e.g., online-only, pickup-only, membership exclusive offering, etc.) can be removed. Suggested predicted items with substantial similarity can be presented to the user and/or automatically populated based on predetermined user preferences/permissions (e.g., the predictive model can identify previous substitutions, replacements, and/or actions taken historically by the user based on inadequate item quantity, type, brand, and/or general availability and/or can extrapolate the same from similar users). When the customer provides feedback within the predetermined feedback time-period (before checkout and/or before fulfillment), feedback features can be extracted from this feedback using a feedback-based prediction model. The feedback-based prediction model can be included in the Feedback Loop Pipeline 370c. These feedback features can include, for one or more items, replenishment features (comprising e.g., quantity and interval), “add” features associated with one or more items added to the generated/populated cart (comprising e.g., count and rate, i.e., how many and how often), “reject” features associated with one or more items rejected/removed from the generated/populated cart (comprising e.g., count and rate), and “return” features associated with one or more items returned/refunded from the generated/populated cart (comprising e.g., count and interval). The system can update the daily order predictions based on signals indicating that a predicted item was recommended by the predictive model but was not accepted by the customer, a predicted item was not recommended by the predictive model but was added by the customer, and/or a predicted item was recommended by the predictive model but was returned by the customer.

The ranked predicted items for repurchase can be reranked (e.g., by the Feedback Loop Pipeline 370c) based on updated essentiality using a dynamic feedback loop that improves predicted item accuracy using ongoing store and online transaction data. For example, the reranking can be based on the feedback features and/or feedback features of similar users (e.g., users within a same order predictability cohort and/or based on demographics, geographic regions, frequently purchased/repurchased items, etc.).

Throughout the process, the dynamic feedback loop can re-rank items based on ongoing customer interactions and/or ongoing similar user interactions. This feedback component incorporates machine learning processes to continuously improve prediction accuracy by adjusting recommendations according to customer behavior changes. Feedback features extracted include replenishment features (e.g., quantity and interval), “add” features (e.g., count and rate), “reject” features (e.g., count and rate), and “return” features (e.g., count and interval). The feedback features can be included in the basket features, the item features, the customer and customer-item features, etc. Thus, the daily order predictions can be updated based on items recommended but not accepted, items added by the customer, and/or items returned by the customer, etc.

By integrating these sophisticated algorithms and machine learning techniques, the replenishment system can address the technical problem of reducing manual intervention in grocery shopping, optimizing available e-commerce website bandwidth, reducing network congestion, and/or freeing up e-commerce website database resources, thus representing a significant advancement in e-commerce technology. Furthermore, the efficiency and accuracy of order prediction and automated cart creation is improved, thus increasing customer satisfaction and conversion.

The methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

FIG. 5A illustrates a tree-based essentials prediction sub-process of a method for order prediction and automated cart creation, according to an example embodiment. For example, the example embodiment of FIG. 5A can be used to perform step 401 illustrated and described with reference to FIG. 4 by the Essentials Prediction Pipeline 370a illustrated and described with reference to FIGS. 3A and 3B.

FIG. 5B illustrates a customer segmentation sub-process of a method for order prediction and automated cart creation, according to an example embodiment. For example, the example embodiment of FIG. 5B can be used to perform step 404 illustrated and described with reference to FIG. 4 by the Customer Segmentation Pipeline 370b illustrated and described with reference to FIGS. 3A and 3B.

FIG. 5C illustrates a feedback loop for item reranking sub-process of a method for order prediction and automated cart creation, according to an example embodiment. For example, the example embodiment of FIG. 5C can be used to perform aspects of method 400 described with reference to FIG. 4 by the Feedback Loop Pipeline 370c illustrated and described with reference to FIGS. 3A and 3B.

The foregoing is provided for purposes of illustrating, explaining, and describing embodiments of these disclosures. Modifications and adaptations to these example embodiments will be apparent to those skilled in the art and may be made without departing from the scope or spirit of these disclosures.

In view of all the above, various embodiments disclosed herein include: (1) an automated, no-touch grocery shopping solution that handles the entire process from item selection to order creation and checkout without requiring manual actions from customers; (2) an adaptive customer segmentation system that dynamically identifies high-predictability customers based on up-to-date predictability, purchase cadence, and engagement metrics for a tailored shopping experience; (3) an implementation of a dynamic item re-ranker based on ongoing customer interactions, ensuring recommendation evolution based on real-time customer behavior changes; (4) an integration of multiple machine learning algorithms (e.g., grouping algorithms (such as single order), XGBoost, etc.) to optimize different aspects of the replenishment process, including customer segmentation, item prediction, and basket size estimation; (5) a sophisticated feedback loop that rapidly incorporates customer modifications to improve future predictions, adjusting to changing preferences more quickly than traditional retraining methods; (7) an automated creation and management of replenishment orders based on predicted customer needs, with built-in flexibility for customer review and modification; (8) a prediction of not only which items to replenish but also optimal quantities, basket sizes, and replenishment timing; (9) an integration of inventory status checks and fulfillment type eligibility into the automated order creation process; (10) a customizable notification system that allows customers to review and modify predicted orders within a specified timeframe before automatic checkout; and/or (11) an ability to adapt to different purchase frequencies (e.g., weekly, bi-weekly) and potentially more flexible intervals based on individual customer patterns. Although example embodiments of a computer-implemented method for order prediction and automated cart creation via a replenishment system using essentials predictions for order predictability segmented users, example embodiments of the system 300 and/or computer-readable program instructions therefor have been illustrated and described herein, it shall be understood by those skilled in the art that various changes may be made without departing from the spirit or scope of the disclosure. Accordingly, the disclosure of the example embodiments is intended to be illustrative of the scope of the disclosure and is not intended to be limiting. It is intended that the scope of the disclosure shall be limited only to the extent required by the appended claims.

Replacement of at least one claimed element constitutes reconstruction and not repair. Additionally, benefits, other advantages, and solutions to problems have been described regarding example embodiments. The benefits, advantages, solutions to problems, and any element or elements that may cause any benefit, advantage, or solution to occur or become more pronounced, however, are not to be construed as critical, required, or essential features or elements of any or all the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
a non-transitory computer-readable medium storing computing instructions that, when executed on the processor, cause the processor to:
for each profile of a plurality of profiles:
input basket features, item features, and order features into a predictive model,
output daily order predictions by the predictive model, wherein the daily order predictions include predicted items for repurchase, a predicted basket size comprised of an aggregate quantity of the predicted items for repurchase, and a predicted individual quantity of each of the predicted items for repurchase,
input the daily order predictions into a grouping algorithm to output an order predictability;
segment the profile into an order predictability cohort of a plurality of order predictability cohorts based on the order predictability, wherein each order predictability cohort of the plurality of order predictability cohorts corresponds to a respective predetermined threshold of order predictability;
automate a cart creation for at least one daily order prediction of the daily order predictions when the order predictability cohort belongs to at least one predetermined order predictability cohort of the plurality of order predictability cohorts; and
automate a checkout of the cart creation for the at least one daily order prediction of the daily order predictions when the profile does not provide feedback within a predetermined feedback time-period.

2. The system of claim 1, wherein the non-transitory computer-readable medium stores computing instructions that cause the processor to:
responsive to receiving feedback within the predetermined feedback time-period, extract feedback features from the feedback using a feedback-based prediction model, wherein the feedback features include:
replenishment features comprising quantity and interval,
add features comprising count and rate,
reject features comprising count and rate, or
return features comprising count and interval; and
update the daily order predictions based on:
at least one predicted item of the predicted items that was recommended by the predictive model but was not accepted by a customer associated with the profile,
at least one predicted item of the predicted items that was not recommended by the predictive model but was added by the customer associated with the profile, or
at least one predicted item of the predicted items that was recommended by the predictive model but was returned by the customer associated with the profile.

3. The system of claim 1, wherein the non-transitory computer-readable medium stores computing instructions that cause the processor to:
train the predictive model by:
inputting historical store and online transaction data associated with a predetermined historical time-period for the plurality of profiles;
extracting the basket features for the plurality of profiles, wherein the basket features include order cadence and order status, and wherein the order status includes at least one of amendments or substitutions;
extracting the item features for the plurality of profiles, wherein the item features include item metadata and global order cadence and frequency;
extracting customer features and customer-item features for the plurality of profiles, wherein the customer features and the customer-item features include total order counts, days since last order, and a recency of order; and
inputting evaluation labels derived from a predetermined future time-period following the predetermined historical time-period to assess a performance of the predictive model on previously unseen data,
wherein the plurality of profiles are associated with a plurality of customers, and wherein the plurality of customers include active purchasers, training customers, and evaluation customers.

4. The system of claim 1, wherein the predictive model comprises a tree-based essentials prediction model, wherein the daily order predictions include essential predicted items from among the predicted items, and wherein the essential predicted items are needed for repurchase on at least one of a weekly basis or a biweekly basis.

5. The system of claim 1, wherein the instructions that cause the processor to output the daily order predictions further cause the processor to rank the predicted items for repurchase based on essentiality.

6. The system of claim 5, wherein the non-transitory computer-readable medium stores computing instructions that cause the processor to re-rank the predicted items for repurchase based on a dynamic feedback loop that improves predicted item accuracy based on ongoing store and online transaction data.

7. The system of claim 1, wherein the instructions that cause the processor to input the daily order predictions into the grouping algorithm further cause the processor to:
identify actual orders associated with a predetermined historical time-period, wherein the actual orders include consecutive-actual orders;
group the consecutive-actual orders; and
evaluate multiple daily order predictions of the daily order predictions that precede each of the consecutive-actual orders to reduce data analysis noise for accuracy of the output of the order predictability.

8. The system of claim 7, wherein the grouping algorithm is single order.

9. The system of claim 1, wherein each of the plurality of order predictability cohorts corresponds to a tier from among a plurality of tiers for the order predictability, wherein the tiers for the order predictability include 1) a high-predictability tier, 2) a moderate-predictability tier, 3) a low-predictability tier, and 4) a non-predictability tier, and wherein the at least one predetermined order predictability cohort includes the high-predictability tier and the moderate-predictability tier.

10. The system of claim 1, wherein the segmenting into the order predictability cohort of the plurality of order predictability cohorts based on the order predictability is associated with a predetermined historical time-period and is performed on a weekly basis, and wherein the predetermined historical time-period is a prior month.

11. The system of claim 1, wherein the segmenting the profile into the order predictability cohort of the plurality of order predictability cohorts based on the order predictability is further based on:
a purchase cadence associated with a first predetermined historical time-period;
in-home engagement, including delivery counts over a second predetermined historical time-period; and
customer engagement, including order counts and basket sizes over the first predetermined historical time-period.

12. A computer-implemented method:
for each customer of a plurality of customers:
inputting basket features, item features, and order features into a predictive model,
outputting daily order predictions by the predictive model, wherein the daily order predictions include predicted items for repurchase, a predicted basket size comprised of an aggregate quantity of the predicted items for repurchase, a predicted individual quantity of each of the predicted items for repurchase, and a ranking of the predicted items for repurchase based on essentiality, wherein the predictive model is a tree-based predictive model,
inputting the daily order predictions into a grouping algorithm to output an order predictability, wherein the grouping algorithm is single order;
segmenting the customer into an order predictability cohort of a plurality of order predictability cohorts based on the order predictability, wherein each order predictability cohort of the plurality of order predictability cohorts corresponds to a predetermined threshold of order predictability;
automating a cart creation for at least one daily order prediction of the daily order predictions when the order predictability cohort belongs to at least one predetermined order predictability cohort of the plurality of order predictability cohorts; and
automating a checkout of the cart creation for the at least one daily order prediction of the daily order predictions when the customer does not provide feedback within a predetermined feedback time-period,
wherein when the customer does provide the feedback within the predetermined feedback time-period, feedback features are extracted from the feedback using a feedback-based prediction model, and wherein the predictive model is updated to output reranked predicted items of the predicted items based on the feedback features.

13. The computer-implemented method of claim 12, further comprising:
re-ranking the ranking of the predicted items for repurchase as the reranked predicted items based on a dynamic feedback loop that improves predicted item accuracy based on ongoing store and online transaction data.

14. The computer-implemented method of claim 12, wherein the inputting the daily order predictions into the grouping algorithm to output the order predictability further comprises:
identifying actual orders associated with a predetermined historical time-period, wherein the actual orders include consecutive-actual orders;
grouping the consecutive-actual orders; and
evaluating multiple daily order predictions of the daily order predictions that precede each of the consecutive-actual orders to reduce data analysis noise for accuracy of the output of the order predictability.

15. The computer-implemented method of claim 12, wherein each of the plurality of order predictability cohorts corresponds to a tier from among a plurality of tiers for the order predictability, wherein the tiers for the order predictability include 1) a high-predictability tier, 2) a moderate-predictability tier, 3) a low-predictability tier, and 4) a non-predictability tier, and wherein the at least one predetermined order predictability cohort includes the high-predictability tier and the moderate-predictability tier.

16. The computer-implemented method of claim 12, wherein the segmenting into the order predictability cohort of the plurality of order predictability cohorts based on the order predictability is associated with a predetermined historical time-period and is performed on a weekly basis, and wherein the predetermined historical time-period is a prior month.

17. The computer-implemented method of claim 12, wherein the segmenting the customer into the order predictability cohort of the plurality of order predictability cohorts based on the order predictability is further based on:
a purchase cadence associated with a first predetermined historical time-period;
in-home engagement, including delivery counts over a second predetermined historical time-period; and
customer engagement, including order counts and basket sizes over the first predetermined historical time-period.

18. A non-transitory computer-readable medium storing instructions that upon execution by a processor, cause the processor to perform operations including a computer-implemented method, the computer-implemented method comprising:
for each customer of a plurality of customers:
inputting basket features, item features, and order features into a predictive model,
outputting daily order predictions by the predictive model, wherein the daily order predictions include predicted items for repurchase, a predicted basket size comprised of an aggregate quantity of the predicted items for repurchase, a predicted individual quantity of each of the predicted items for repurchase, and a ranking of the predicted items for repurchase based on essentiality, and
inputting the daily order predictions into a grouping algorithm to output an order predictability;
segmenting the customer into an order predictability cohort of a plurality of order predictability cohorts based on the order predictability, wherein each order predictability cohort of the plurality of order predictability cohorts corresponds to a predetermined threshold of order predictability;
automating a cart creation for at least one daily order prediction of the daily order predictions when the order predictability cohort belongs to at least one predetermined order predictability cohort of the plurality of order predictability cohorts;
removing certain predicted items of the predicted items that have subscriptions, are out-of-stock, or have an ineligible fulfillment type from the cart creation; and
automating a checkout of the cart creation for the at least one daily order prediction of the daily order predictions when the customer does not provide feedback within a predetermined feedback time-period.

19. The non-transitory computer-readable medium storing instructions of claim 18, wherein the computer-implemented method further comprises:
re-ranking the ranking of the predicted items for repurchase based on a dynamic feedback loop that improves predicted item accuracy based on ongoing store and online transaction data.

20. The non-transitory computer-readable medium storing instructions of claim 18, wherein the inputting the daily order predictions into the grouping algorithm to output the order predictability further comprises:
identifying actual orders associated with a predetermined historical time-period, wherein the actual orders include consecutive-actual orders;
grouping the consecutive-actual orders; and
evaluating multiple daily order predictions of the daily order predictions that precede each of the consecutive-actual orders to reduce data analysis noise for accuracy of the output of the order predictability.
